(19) United States
(12) Patent Application Publication
(10) Pub. No.: US 2024/0391631 A1
(43) Pub. Date: Nov. 28, 2024

(54) LABELING MACHINE WITH AN EXTRACTION HOOD

(71) Applicant: P.E. LABELLERS S.P.A., Porto Mantovano (IT)

(72) Inventor: Riccardo BARDINI, Torri Del Benaco (IT)

(21) Appl. No.: 18/690,858

(22) PCT Filed: Aug. 30, 2022
(86) PCT No.: PCT/EP2022/074078

§ 371 Date: Mar. 11, 2024

(30) Foreign Application Priority Data
Sep. 14, 2021 (IT) 102021000023630

(51) Int. Cl. B65C 9/22; B65C 9/00

(52) U.S. Cl. CPC B65C 9/22; B65C 2009/0071

(57) ABSTRACT

A labeling machine including a conveyor for moving containers to be labeled along an advancement path and at least one labeling assembly arranged along the advancement path and provided with labeling elements adapted to apply at least one respective label to the containers that transit on the conveyor. The labeling elements include at least one adhesive application assembly designed to supply adhesive to the labels before their transfer to the containers; at least one extraction hood is mounted on the labeling assembly and can move on command, with respect to the labeling assembly, between an active position, in which it is arranged above the adhesive application assembly, and an inactive position, in which it is arranged at least partially outside of the work area of the labeling assembly.

The present invention relates to a labeling machine.

Labeling machines are known which allow to apply on containers labels obtained from the cutting of a continuous label ribbon which is wound in a spool and on which the labels are printed in succession.

Typically, labeling machines of this type have a conveyor of the containers to be labeled, which is constituted by a rotating carousel, which is provided with rotatable supporting plates for the individual containers, capable of rotating the containers around the corresponding axes, and around which one or more labeling assemblies are arranged which are designed to apply a respective label on the containers that transit on the carousel.

Each labeling assembly generally has an unwinding assembly which is designed to unwind the label ribbon from its spool and at the exit of which a rotating drum is arranged which is designed to receive the label ribbon provided by the unwinding assembly and retain it in adhesion, on its own lateral surface, by virtue of suction ports formed on its lateral surface.

In particular, some machines have, in mutual succession, a first drum, termed cutting drum, which is provided with blades that allow to cut the label ribbon at the separation region between two consecutive labels, and a second drum, known as transfer drum, which receives the labels separated after cutting in order to move them to adhere to the respective container that is arriving on the carousel.

In other machines there is a single drum which is fed directly by the unwinding assembly and is known as cutting and transfer drum and allows to both cut the label ribbon, by virtue of blades mounted thereon, and transfer the cut labels to the corresponding containers.

The label ribbon may be of the pre-adhesive type and have, therefore, on its face designed to contact the containers, pre-applied portions of adhesive or, as an alternative, may be without pre-applied adhesive and in this case an adhesive application assembly is provided on the labeling machines and applies two portions of adhesive to the ends of the labels, before said labels are transferred to the containers.

Typically, the adhesive application assembly is constituted by a glue roller, which is laterally adjacent to the transfer drum or to the cutting and transfer drum.

During the operation of the machine, at the glue roller, adhesive or solvent fumes and vapors are generated which must be expelled into the outside environment.

For this purpose, above the glue roller an extraction hood for the adhesive and solvent fumes and vapors is generally arranged, which is connected to a discharge duct that allows to convey the solvent vapors above the labeling assembly and then above the carousel, then releasing them toward the outside environment.

The extraction hood and the discharge duct are currently fixed to the frame of the carousel.

However, the presence of protections around said carousel and the need to be able to adjust in height the labeling assembly with respect to the carousel frame, in order to vary the application height of the labels on the containers, force to arrange the extraction hood at a distance from the glue roller that is not optimal for ensuring the correct extraction of the solvent vapors.

It should be noted that placing the extraction hood closer to the glue roller would entail the disadvantage of creating an obstacle to the execution of interventions for maintenance or replacement of the components of the labeling assembly, which must necessarily be carried out by operators by acting from above on the labeling assembly.

The aim of the present invention is to provide a labeling machine that is capable of improving the background art in one or more of the above-mentioned aspects.

Within this aim, an object of the invention is to provide a labeling machine that allows to ensure the optimal evacuation toward the outside environment of the solvent vapors generated at the glue roller.

Another object of the invention is to provide a labeling machine that allows the operators to intervene conveniently from above on the components of the labeling assembly.

Another object of the present invention is to provide a labeling machine that is compact and structurally simple to provide.

Another object of the invention is to provide a labeling machine capable of giving the greatest assurances of reliability and safety in use.

Furthermore, an object of the present invention is to overcome the drawbacks of the background art in a manner that is alternative to any existing solutions.

Not least object of the invention is to provide a labeling machine that is competitive also from a purely economic standpoint.

This aim and these and other objects which will become better apparent hereinafter are achieved by a labeling machine according to claim 1, optionally provided with one or more of the characteristics of the dependent claims.

Further characteristics and advantages of the invention will become better apparent from the description of a preferred but not exclusive embodiment of the machine according to the invention, illustrated by way of non-limiting example in the accompanying drawings, wherein:

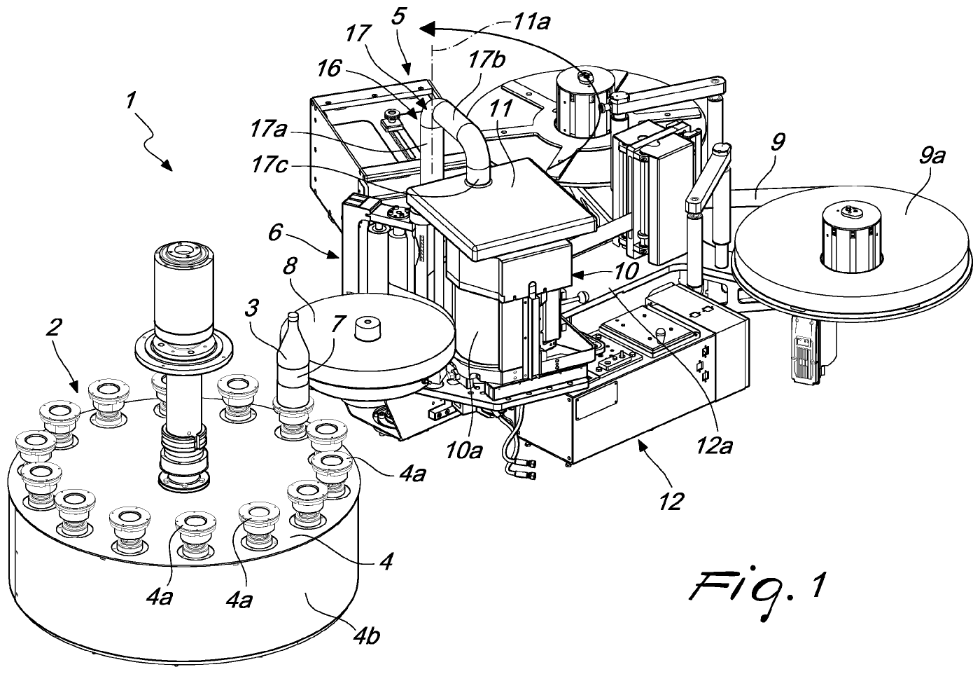

FIG. 1 is a perspective view of the labeling machine according to the invention;

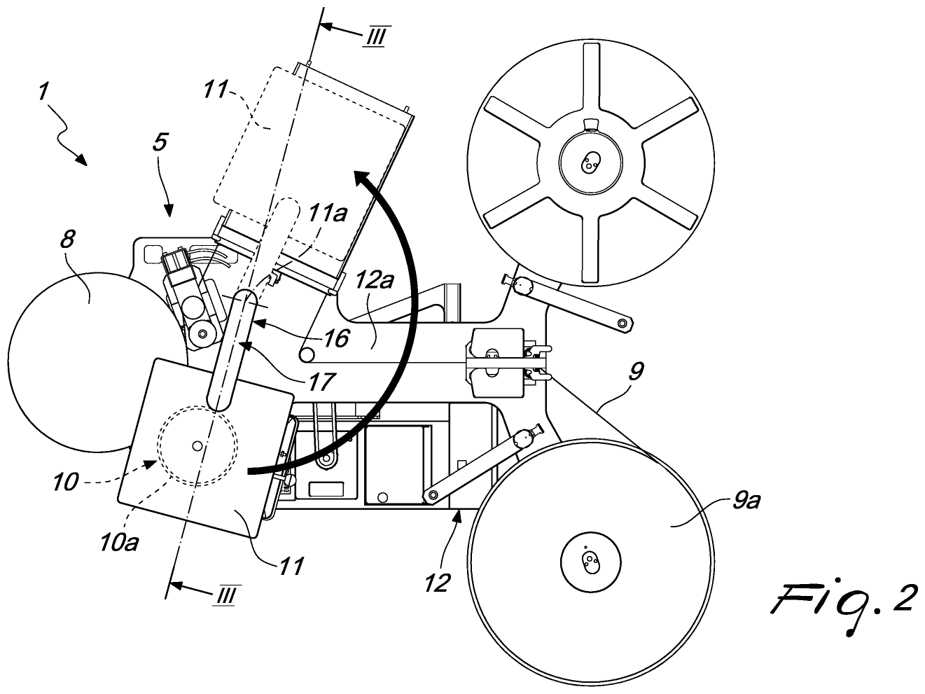

FIG. 2 is a top plan view of a labeling assembly of the labeling machine according to the invention;

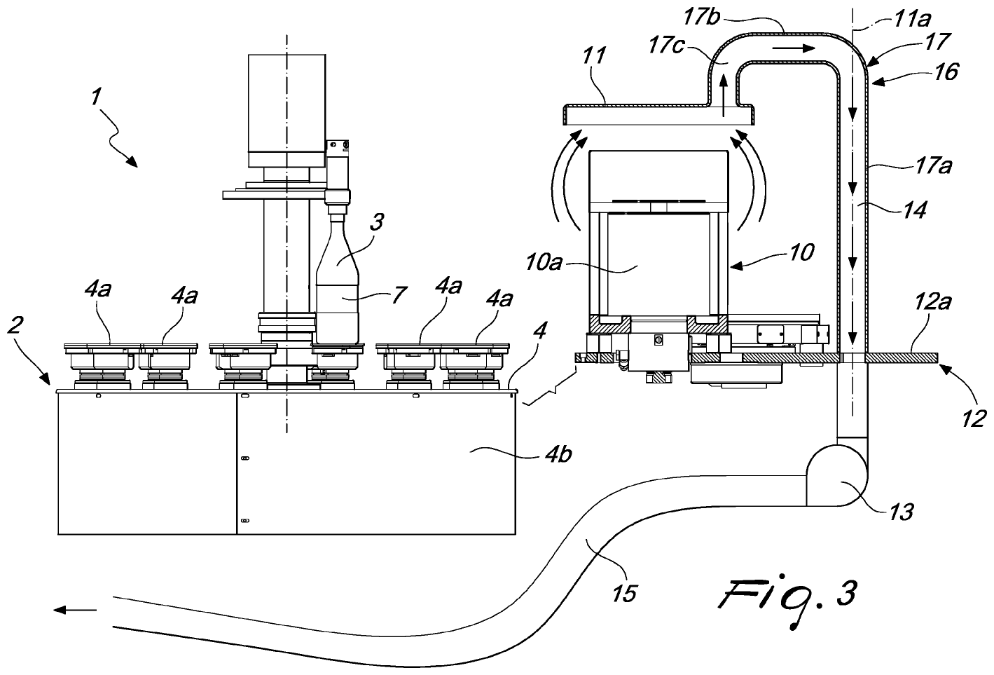

FIG. 3 is a schematic and partially sectional lateral elevation view of the labeling machine according to the invention, with parts omitted for the sake of simplicity.

With reference to the figures, the labeling machine according to the invention, generally designated by the reference numeral 1, comprises a conveyor 2 for moving the containers 3 to be labeled along an advancement path, which is constituted for example by a rotating carousel 4 provided peripherally with rotating plates 4a for supporting the individual containers 3.

Along the advancement path of the containers 3 there is at least one labeling assembly 5 that has labeling means 6 adapted to apply the labels 7 on the containers 3 that transit on the conveyor 2.

In particular, the labeling means 6 comprise a drum 8, which may be a transfer drum or a cutting and transfer drum and faces the containers 3 in order to transfer to said containers the labels 7 obtained from the cutting of a label ribbon 9, picked up from a spool 9a, in a per se known manner.

The labeling means 6 comprise, moreover, at least one adhesive application assembly 10 designed to supply adhesive to the labels 7 before their transfer to the containers 3 on the part of the drum 8.

For example, the adhesive application assembly 10 comprises a glue roller 10a, which is arranged laterally to the drum 8 to contact the labels 7 or the label ribbon 9 entrained by the drum 8.

The labeling machine comprises at least one extraction hood 11, which is mounted on the labeling assembly 5 and can move on command, with respect to the labeling assembly 5, between an active position, shown in FIG. 1 and in solid lines in FIG. 2, in which the extraction hood 11 is arranged above and at the adhesive application assembly 10, so as to be able to effectively remove vapors or fumes coming from the adhesive application means 10, and an inactive position, shown in dashed lines in FIG. 2, in which it is arranged at least partially outside of the work area of the labeling means 6, so as to avoid hindering the operators, during interventions for maintenance, repair or format change performed on the labeling assembly 5.

In particular, when the extraction hood 11 is brought to the inactive position, it may be located, for example, outside at least the region of the labeling means 6 in which the drum 8 and the adhesive application means 10 are arranged.

The extraction hood 11 may, for example, be structured in a per se known manner with a covering body, for example, with a substantially planar shape or other suitable shape, provided with an open lower face, designed to be directed toward the adhesive application assembly 10, which allows the collection of the vapors or fumes that arrive from the adhesive application assembly 10.

The extraction hood 11 may furthermore have, conveniently, a size that is sufficient at least to cover in an upper region the adhesive application assembly 10 when it is in the active position.

Advantageously, when the extraction hood 11 is in the active position, it is arranged closer to the adhesive application assembly 10, preferably at the minimum possible distance from the glue roller 10a, so as to ensure the optimal collection of the vapors and fumes produced by the adhesive application assembly 10.

Conveniently, the extraction hood 11 is connected to conveyance means that allow to convey the fumes or vapors collected by said extraction hood toward the lower part of the labeling assembly 5 and, more particularly, below the labeling means 6, as will be explained better hereinafter.

In greater detail, the labeling assembly 5 comprises a base framework 12, which forms, conveniently in its upper part, a worktop 12a, on which the adhesive application assembly 10 is mounted, as well as the other components of the labeling means 6.

The base framework 12 may be fixed to the frame 4b of the carousel 4 or may be associated therewith detachably and in this case may be supported by a per se known transport carriage, not shown.

In particular, the extraction hood 11 is conveniently supported by the base framework 12 of the labeling assembly 5 so that it can rotate, with respect to the base framework, about a rotation axis 11a, in order to allow its movement between the active position and the inactive position.

Advantageously, the rotation axis 11a of the extraction hood 11 is substantially perpendicular to the worktop 12a and is arranged in an eccentric position with respect to the extraction hood 11.

The extraction hood 11 is furthermore connected to an extraction device 13, which is arranged below the worktop 12a so that the vapors or fumes extracted by the extraction hood 11 can be conveyed in a region of the machine that lies below the worktop 12a.

In particular, the extraction hood 11 is connected to a discharge duct 14, which passes through the worktop 12a and is connected to the inlet of the extraction device 13.

Conveniently, the extraction device 13 can be mounted on the base framework 12 of the labeling assembly 5 or can be optionally mounted also on the frame 4b of the carousel 4, below the plane on which the plates 4a are positioned, and in this case the discharge duct 14 is extended so as to pass through the perimetric wall of the frame 4b of the carousel 4 as well and is conveniently provided so as to be at least partially flexible, in order to allow to vary the application height of the labels 7 on the containers 3 by the labeling assembly 5.

At its outlet, the extraction device 13 is connected in turn to an evacuation duct 15, preferably constituted by a flexible hose, which is connected to the discharge manifold of the department or facility, if present, or otherwise is extended toward the upper region of the carousel 4, in order to allow the discharge of the vapors or fumes collected by the extraction hood 11 toward the outside environment.

According to the illustrated embodiment, the extraction hood 11 is supported, conveniently in a suspended condition above the labeling means 6, by a supporting element 16, which is mounted rotatably on the worktop 12a of the base framework 12 of the labeling assembly 5, about the rotation axis 11a.

The discharge duct 14 is advantageously formed inside the supporting element 16.

In particular, the supporting element 16 is, conveniently, provided by a tubular body 17, which in turn provides the discharge duct 14.

More particularly, the tubular body 17 is advantageously contoured so as to have at least one first portion 17a, which extends substantially vertically above the worktop 12a of the base framework 12.

At its lower end, the first portion 17a of the tubular body 17 is mounted on the worktop 12a so that it can rotate, about its own axis, with respect to the base framework 12, so as to form, with its own axis, the rotation axis 11a of the extraction hood 11.

The tubular body 17 furthermore has at least one second portion 17b, which is connected, at one end, to the upper end of the first portion 17a and protrudes substantially radially with respect to the first portion 17a.

In turn, the second portion 17b is connected, at its other end, to the extraction hood 11, preferably by means of a third portion 17c of the tubular body 17 that is extended substantially vertically from the second portion 17b.

The use of the labeling machine, according to the invention, is as follows.

When the labeling machine is operating, the extraction hood 11 is arranged in the active position, where it is arranged proximate to the adhesive application assembly 10, so as to collect in an optimal manner the vapors and fumes that arrive from the adhesive application assembly 10 and allow, by means of the discharge duct 14, their downward conveyance until they are brought below the worktop 12a of the labeling assembly 5 by the extraction device 13, which then pushes them toward the outside environment through the evacuation duct 15.

When an intervention of the operators on the labeling means 6 is required, for example for maintenance requirements or even just for changing the drum 8, the operator manually moves the extraction hood 11 from the active position to the inactive position, making it rotate about the rotation axis 11a, so as to position the extraction hood 11 outside the work area of the adhesive application means 10 and, more generally, of the labeling means 6, so as to leave free from the space occupation of the extraction hood 11 the space located above the labeling means 6, consequently allowing the operator comfortable access to the labeling means 6 from above.

In practice it has been found that the invention achieves the intended aim and objects, providing a labeling machine that allows to have, during the operation of the machine, the extraction hood in an optimum position for collecting the vapors and fumes produced by the adhesive application means of the labels, while allowing the operators comfortable access to the labeling means during interventions for maintenance, repair or format change.

The invention thus conceived is susceptible of numerous modifications and variations, all of which are within the scope of the appended claims.

Thus, for example, nothing forbids to provide actuation means, functionally connected to the extraction hood and activatable by operator command, in order to actuate the transition of the extraction hood from the active position to the inactive position.

All the details may furthermore be replaced with other technically equivalent elements.

In practice, the materials employed, as well as the contingent shapes and dimensions, may be any according to the requirements and the state of the art.

The disclosures in Italian Patent Application No. 102021000023630 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-10. (canceled)

11. A labeling machine comprising a conveyor for moving containers to be labeled along an advancement path and at least one labeling assembly arranged along said advancement path and provided with labeling means configured to apply at least one respective label to the containers that transit on said conveyor, said labeling means comprising at least one adhesive application assembly designed to supply adhesive to the labels before transfer of the labels to the containers, further comprising at least one extraction hood which is mounted on said labeling assembly and configured to move on command, with respect to said labeling assembly, between an active position, in which the extraction hood is arranged above said adhesive application assembly, and an inactive position, in which the extraction hood is arranged at least partially outside of a work area of said labeling means.

12. The machine according to claim 11, wherein said extraction hood is arranged, in said active position, at a closer distance with respect to said adhesive application assembly.

13. The machine according to claim 11, wherein said extraction hood is connected to means for conveyance of fumes or vapors collected by said extraction hood toward a lower part of said labeling assembly.

14. The machine according to claim 11, wherein said labeling assembly comprises a base framework which forms a worktop, on which said adhesive application assembly is mounted, said extraction hood being supported by said base framework so that the extraction hood can rotate, with respect to said base framework, about a rotation axis, for a movement thereof between said active position and said inactive position.

15. The machine according to claim 14, wherein said extraction hood is connected to an extraction device arranged below said worktop.

16. The machine according to claim 15, wherein said extraction hood is connected to a discharge duct, which passes through said worktop and is connected to said extraction device.

17. The machine according to claim 14, wherein said extraction hood is supported by a supporting element which is mounted so that it can rotate on said worktop about said rotation axis.

18. The machine according to claim 16, wherein said discharge duct is formed inside said supporting element.

19. The machine according to claim 17, wherein said supporting element comprises a tubular body, which has at least one first portion which extends substantially vertically above said worktop and is mounted, at a lower end thereof, so that it can rotate about its own axis with respect to said base framework, and at least one second portion which is connected, at one end, to an upper end of said first portion and extends substantially radially with respect to said first portion, said second portion being connected, at another end, to said extraction hood.

20. The machine according to claim 15, wherein said extraction device is connected to a duct for evacuation toward an outside environment.
